(19) United States
(12) Patent Application Publication
(10) Pub. No.: US 2010/0144362 A1
(43) Pub. Date: Jun. 10, 2010

(54) METHOD OF CONFIGURING A STATION FOR ACCESSING A SERVICE AND AN ASSOCIATED CONTROLLER, ACCESS NETWORK, ACCESS STATION, AND COMPUTER PROGRAM

(75) Inventors: Emmanuelle Bernard, Paris (FR); Emmanuelle Bonout, Toulouse (FR); Gael Champion, Suresnes (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/446,134

(22) PCT Filed: Oct. 16, 2007
(86) PCT No.: PCT/FR2007/052167

§ 371 Date: Jul. 24, 2009

(30) Foreign Application Priority Data
Oct. 17, 2006 (FR) 0654329

(51) Int. Cl. H04W 72/04

(52) U.S. Cl. 455/452.1

(57) ABSTRACT

The invention relates to a method for configuring an SAI parameter of a terminal for accessing a service supplied by a communication network (12). According to the invention, said method comprises, for a service accessible by means of a plurality of radio terminals forming an access network connected to the communication network: on reception of a request (20) for the configuration of the SAI parameter comprising a localisation indication of the radio terminal, a step of associating a geographical region with the radio terminal on the basis of said localisation indication; a step of dynamically allocating a pseudo value to the parameter, complying with the requirement of a single occurrence of the pseudo value in the geographical region; and on reception of a request for access to a service from said radio terminal, a step of converting the pseudo value into the possible value of selected parameter into an SAI parameter value selected from a list of possible values, defined by the communication network for the geographical region.

### CROSS-REFERENCE TO RELATED APPLICATIONS

This Application is a Section 371 National Stage Application of International Application No. PCT/FR2007/052167, filed Oct. 16, 2007 and published as WO 2008/047039 on Apr. 24, 2008, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to a method of configuring a parameter of a station for accessing a service.

The present disclosure also relates to a controller of a service access station using the method.

The present disclosure further relates to a service access station able to send a configuration request to the controller.

The present disclosure further relates to a service access network using the controller.

The disclosure finally relates to a computer program for executing the method when it is executed by a processor.

The invention applies particularly, although not exclusively, to second or third generation communications systems such as the GSM, GPRS, or UMTS and future developments thereof.

### BACKGROUND OF THE DISCLOSURE

A conventional mobile telephone network, for example a UMTS (Universal Mobile Telecommunications system) network, consists of a wireless access network comprising public access stations, known as base stations, and a core network, which manages the service offered and routes calls to fixed networks such as the fixed public telephone network, the Internet, etc. Such mobile telephone networks are generally organized into cells, each of which is associated with a base station and is of a size that varies as a function of user density, the geography of the terrain, the power of the associated base station, etc. In a UMTS network in particular, adjacent cells of the network use different scrambling codes (SC) in accordance with code division multiple access (CDMA) technology, for example.

In a conventional UMTS wireless access network, the installation of public access stations is planned, in particular by allocating values of configuration parameters beforehand. These parameters include in particular a set of parameters defined in the 3GPP Technical Specification TS 23.002:

the Public Land Mobile Network (PLMN) code, which identifies the mobile network of a given operator in a given country; each mobile telephone network is managed by an operator, is associated with a geographical area (conventionally a state), and is identified by a PLMN code that is specific to it; a mobile terminal can only access the mobile telephone network managed by the operator with which it has a contract, or possibly with another network with which its operator has reciprocal roaming agreements; after it has been connected to an authorized PLMN, the mobile terminal monitors signals coming from the various access stations that it receives, selects the signal received with the best quality, and is attached to the cell from which that signal comes;

the Location Area Code (LAC), which is assigned to a cell or to a group of cells, is used to manage the mobility of a user terminal, and defines a location area; an LAC has 65536 possible values;

the Service Area Code (SAC), which is assigned to a cell or to a group of cells and is used to define a service area; an SAC has 65536 possible values; service areas were introduced in the UMTS to enable the cellular coverage area or AS (Access Stratum) layer to be independent of the NAS (Non Access Stratum) layer offering services to the mobile terminal; for broadcast services, the definition of a broadcast area is not linked to the wireless coverage criteria but to the geographical area concept, and the cells to which information is broadcast are then determined in the UMTS “macroscopic” access network or UTRAN (Universal Terrestrial Wireless Access Network). In the GSM, broadcasting is based on cells, which rules out independence of the service layer and the access layer, and some limitations have been identified. The service area as defined by the Service Area concept is a geographical area independent of the number of 3G cells in that area.

Concatenating the first two parameters forms a parameter referred to as the Localization Area Identifier (LAI). In a UMTS network, for example, such parameters are used for access control in particular.

Concatenating these three parameters forms a parameter referred to as the Service Area Identifier (SAI). In a UMTS network, for example, such parameters are used by services that are based on the location of the mobile terminal, for example to route an emergency call to the nearest emergency call processing center. It is also possible to use the location information supplied by this parameter SAI in other circumstances, for example in a service enabling a user to find cinemas nearest their current location. To this end, the mobile subscriber's SAI value is recovered by the network, translated into a geographical area, which is correlated can also be mentioned as an example of the use of service areas.

It is therefore clear that assigning a value to one of these parameters for a service access station must satisfy certain constraints, for example constraints linked to the geographical location of the access station, as with the parameters LAI and SAI. However, in an operator network, satisfying these constraints does not give rise to any particular problem, because it is the operator that defines where the access stations are installed.

One drawback of a standard prior art access network is that, to be taken into account by the network when it is installed, a new access station must necessarily have been planned and therefore configured beforehand.

At present the expansion of mobile communications networks is oriented toward offering convergence between mobile networks and fixed telephone networks (such as the public switched telephone network (PSTN) or the Internet).

Given this framework, some operators envisage offering their clients, whether private individuals or businesses, wireless coverage (second generation (2G), third generation (3G) or beyond 3G (B3G)) in the home or in business premises, for example in the form of a wireless access network in the home or limited to business connected to a modem offering high-bit-rate access, for example of the asynchronous digital subscriber line (ADSL) type, or to any other equipment providing access to a high-bit-rate network (for example Fiber To The Home (FTTH)). Below, for simplicity, the expression private wireless access station refers to the system consisting of the access station as such and the equipment providing access to a high-bit-rate network to which it is connected.

Each person can therefore have their own home wireless access station covering their apartment or house. Similarly, in a business context, a company can have one or more wireless access stations on its site to cover its premises. This home or business access station can include an access control system to restrict access to its wireless coverage area to a set of users, for example family, friends, employees of the business, etc.

However, introducing this kind of home wireless coverage service raises the problem of configuring the private access stations, whose locations in the access network have not been planned in advance.

The introduction of any such home wireless coverage service also raises the problem that it increases the number of access stations to the operator's communications network, since it is likely that a large number of private access stations will be added to the public access stations of the base station type already deployed by the operator.

### SUMMARY

An aspect of the present disclosure relates to a method of configuring a parameter SAI of a wireless access station providing access to a service provided by a communications network.

The method of an embodiment of the invention is noteworthy in that, the service being accessible via plurality of wireless access stations forming an access network to said communications network, said method includes:

on reception of a request for configuration of the parameter SAI including an indication of the location of a wireless access station, a step of assigning a geographical area to said wireless access station on the basis of said location indication;

a step of dynamically assigning a pseudovalue to the parameter satisfying a constraint associated with the location of the wireless access station; and

on reception of a request to access a service from said wireless access station, a step of converting the pseudovalue into a value of the parameter SAI selected from a list of possible values defined by the communications network for said geographical area.

Thus an embodiment of the invention solves the technical problem of configuring the parameter SAI of an unplanned service access station in the access network. According to an embodiment of the invention, a newly-installed unplanned wireless access station sends a network controller a request for configuration of its parameter SAI that includes an indication of its location. As well as giving the geographical location of the wireless access station in question, the location indication can define its environment, in particular in terms of the location and/or configuration of adjacent wireless access stations. In response to this request, the controller assigns said wireless access station a value of the parameter SAI that satisfies at least one constraint linked to its location. It begins by assigning the wireless access station a geographical area on the basis of the location indication.

The parameter SAI is used to implement services based on the location of the user terminal or to route an emergency call to a local emergency call processing center. For this type of service, an SAI is matched to a local processing center. A first constraint of the communications network is that there is a limited number of possible SAI values for a geographical area. The fact that a given geographical area is attached to a local emergency call processing center guarantees that all emergency calls coming from private access stations installed in the geographical area will be routed to that local emergency call processing center.

According to another aspect of the invention, the configuration method additionally has the following features:

said assignment step satisfies a second constraint imposing a single occurrence of said value of said parameter in the private access stations adjacent said wireless access station in said geographical area.

This second constraint concerns the parameter LAC in particular, which is likely to be used by an access control mechanism and, as such, must uniquely identify a wireless access station relative to the adjacent access stations. To this end, it is beneficial for there to be a different value of the parameter LA for each wireless access station, or at least the adjacent wireless access stations (for two wireless access stations that are far apart to have the same location area can be tolerated). Referring to the 3GPP Technical Specification TS 24.008, for example, these parameter values have the consequence of triggering a Location Area Update procedure when a mobile terminal attempts to attach itself to a wireless access station. The network then knows at precisely which access station the subscriber is located. Without this constraint, the mobile terminal could attach itself to the adjacent access stations without the network being notified of this.

The parameter SAI is made up by concatenating the values of PLMN, LAC, and SAC. However, PLMN has a value that is fixed for any one operator in a given country. Consequently, the configuration of the parameter SAI in a fixed PLMN is closely tied to the configuration of the above-defined parameters LAC and SAC.

In another aspect of the invention, said assignment step comprises a substep of recovering values assigned to the wireless access stations adjacent said wireless access station and a substep of updating the list of possible values for said wireless access station by eliminating said adjacent values from said list.

The recovery substep can be performed by the wireless access station itself, which monitors messages broadcast by the adjacent wireless access stations and forwards them to a network entity, for example the controller. Such messages contain configuration parameter values, for example values for the parameter LAC for 2G or 3G wireless access stations or values for the parameter SC for 3G wireless access stations.

The recovery substep can also be performed by the controller, which interrogates the adjacent wireless access stations to ascertain the configuration parameter values that have been assigned to them. The values of these parameters, such as the parameter SAC, are not broadcast by the adjacent wireless access stations. In this regard, note that the controller needs to receive beforehand, for example from the wireless access station that submits the configuration request, indications of the locations of the adjacent wireless access stations.

According to the same aspect of the invention, recovering the parameter values assigned to the wireless access stations adjacent the wireless access station awaiting configuration enables updating of the list of possible values of the parameter supplied by the local database.

According to another aspect of the invention, the configuration method further comprises the following characteristics:

said assignment step satisfies a constraint imposing a unique occurrence of said value of said parameter in said geographical area.

A third constraint imposes assigning a value to the parameter SAI that uniquely identifies a wireless access station in the geographical area of a given PLMN.

Satisfying the third constraint in accordance with an embodiment of the invention also has advantages for specific applications such as broadcasting. The broadcasting application, defined in 3GPP Technical Specification TS 25.419, enables a service terminal to broadcast messages to mobile terminals attached to it within its service area. Clearly assigning an SAI pseudovalue specific to a home gateway could enable a service to be offered enabling subscribers to the service to broadcast personalized messages, for example referring to the home gateway's subscriber, of the type “Welcome to the home gateway of Forename Surname!”.

A problem linked to this third constraint arises from the fact that the communications network provides a limited number of possible values of the parameter SAI. If the number of wireless access stations in a geographical area increases, there is a risk of the maximum number of possible values defined by the communications network being reached quickly and being insufficient to satisfy this third constraint.

An embodiment of the invention uses pseudovalues that satisfy the third constraint and are used only for exchanges between the plurality of wireless access stations and the controller. These pseudovalues are then converted by the controller into a value of the parameter SAI that satisfies the first constraint, i.e. that is selected from a list of possible values defined by the communications network for said geographical area.

One advantage of this is that it is not necessary to increase the number of possible values defined by the communications network. The first and third constraints can therefore be satisfied simultaneously without this overloading its resources. A second advantage is that configuring the wireless access station has no repercussions on the operation of the communications network, and in particular that of the core network, which is particularly beneficial because modifications in the core network should be restricted for operation and maintenance reasons. In particular, some modifications cannot be effected dynamically, obliging the operator to preconfigure the nodes with a finite and limited number of planned values.

Thus an embodiment of the invention configures the parameter SAI of a newly-installed wireless access station dynamically, taking account of its geographical location, and also reconfigures periodically a wireless access station whose geographical environment is liable to be modified frequently, for example by installing new wireless access stations. For example, associating the process of configuring the parameter SAI in the wireless access station with a validity period can be envisaged. Once that period has expired, the access station repeats its configuration request to the communications network. An advantage of periodic reconfiguration is that it harmonizes the assignment of configuration parameter values in the access network by taking account of modifications to the environment of the access station.

An embodiment of the invention applies in particular to home private wireless access stations of the second generation (2G), third generation (3G) and beyond 3G (B3G) types mentioned above and controllers constituting gateways to the mobile communications network. It can also be applied to the wireless access stations of the “macroscopic” network of an operator not wishing to reconfigure new wireless access stations that it installs.

According to one advantageous feature, the dynamic assignment step includes a substep of interrogating a local database containing a list of pseudovalues available for the parameter SAI in said geographical area and a substep of selecting a pseudovalue to be assigned to said wireless access station from said list of available pseudovalues, and a stage of updating the list so as to delete the pseudovalue selected from said list.

One advantage of this is that the database provides an up-to-date list of available pseudovalues.

The conversion step advantageously includes a substep of interrogating a database containing a table for converting said pseudovalue into the possible value selected for said parameter in said geographical area.

An advantage of this is that the controller knows how to match the pseudovalue that is used between the wireless access station and the controller to a value of the parameter SAI that satisfies the first constraint. It is this value that is seen by the network in the request sent by the controller.

The method of an embodiment of the invention is preferably such that:

said assignment step satisfies a fourth constraint imposing a homogeneous distribution of the instances of said value of said parameter among the wireless access stations in said geographical area adjacent said wireless access station;

said list indicates a number of instances of said value for the plurality of wireless access stations; and

the selection substep selects the value for which the number of occurrences already assigned in said geographical area is the lowest.

This fourth constraint relates in particular to configuring the parameter LAC, for which it is cumulative with the second constraint. As indicated above, the user terminal location update procedure uses a list of the latest access stations to which the user terminal has attempted to attach, identified by their LAC parameter. It is therefore clear that the fourth constraint aims to minimize the risk of two wireless access stations having the same value of the parameter LAC being in this list simultaneously. To satisfy this fourth constraint, the selection substep uses a pseudorandom algorithm, for example, which, on the basis of said list indicating the number of instances of a value of the parameter for the plurality of wireless access stations installed in the geographical area, selects from that list the value for which the number of instances already assigned in said geographical area is the lowest.

An embodiment of the invention also relates to a controller of access stations providing access to a service provided by a communications network. The controller of an embodiment of the invention is noteworthy in that, said access stations being wireless access stations to a service of said network connected to said controller constituting a gateway to said communications network, said controller is adapted to employ the following means:

on reception of a request for configuration of a parameter SAI including an indication of the location of a wireless access station, assigning a geographical area to said wireless access station on the basis of said location indication;

dynamically assigning a pseudovalue to the parameter satisfying a constraint associated with the location of the wireless access station; and

on reception of a request to access a service from said wireless access station, converting the pseudovalue into a value of the parameter selected from a list of possible values defined by the communications network for said geographical area.

This aspect of the invention concerns in particular the 2G or 3G private access stations defined above, which can be connected to a controller through which passes all traffic between the private access stations and the communications network. This kind of controller offers centralized dynamic configuration of all the access stations for which it is responsible and can also deal with the public access stations of an operator's “macroscopic” access network.

An embodiment of the invention also relates to an access station to a service provided by a communications network.

Said access station is noteworthy in that, the service being accessible via a plurality of wireless access stations connected to said communications network, said wireless access station includes means for sending a request to configure a parameter SAI including at least a location indication to a controller constituting a gateway to the communications network and means for receiving a pseudovalue of the parameter SAI satisfying a constraint associated with the location of the wireless access station.

An advantage of this is that the controller has an overview of the wireless access stations in the access network that have already been configured. This solution further offers the advantage of centralizing the configuration function and of not making the wireless access stations more complex.

An embodiment of the invention also relates to an access network to a service provided by a communications network. Said network is noteworthy in that, the service being accessible via a plurality of wireless access stations connected to said communications network, a wireless access station includes means for sending a request to configure a parameter SAI including at least a location indication to a controller constituting a gateway to the communications network and means for receiving a pseudovalue of the parameter, said controller being adapted to assign a geographical area to said wireless access station on the basis of said location indication, to assign the pseudovalue to the parameter satisfying a constraint associated with the location of the wireless access station, and to send it to the wireless access station in response to said request.

According to an embodiment of the invention, said private access station sends configuration requests to said controller and said controller uses said dynamic assignment means.

An advantage of this is that assignment is centralized for the plurality of wireless access stations. The controller has an overview of the parameter configurations of the wireless access stations for which it is responsible. This centralized solution also avoids making the structure of a wireless access station more complex.

An embodiment of the invention relates finally to a computer program product downloadable from a communications network and/or stored on a computer-readable medium and/or adapted to be executed by a microprocessor.

This kind of computer program product is noteworthy in that it includes program code instructions for executing the method of an embodiment of the invention.

### BRIEF DESCRIPTION OF THE DRAWINGS

Other advantages and features become more clearly apparent on reading the following description of one particular embodiment of the invention, given by way of illustrative and non-limiting example only, and from the appended drawings, in which:

FIG. 1 shows the architecture of a network of wireless access stations that provide access to a service provided by a communications network and are managed by a controller of an embodiment of the invention serving as a gateway between a core network and an access network dedicated to the home wireless coverage service;

FIG. 2 illustrates the steps of the method of an embodiment of the invention for configuring a parameter of a private service access station;

FIG. 3 illustrates the routing of a call to a service from an access station configured by the method of an embodiment of the invention, based on the location of a user terminal; and

FIG. 4 illustrates the assignment of parameters LAC, SAC to private access stations of a geographical area by a method according to one aspect of the invention.

### DETAILED DESCRIPTION OF ILLUSTRATIVE EMBODIMENTS

In the framework of introducing a new service that offers the subscribers of an operator home wireless coverage from private access stations, the general principle of an embodiment of the invention is based on dynamically configuring the private access stations, the deployment and installation of which in a geographical area has not been planned in advance.

It should be noted that, throughout this document, the expression “home wireless coverage” refers to wireless coverage accessible from a private wireless access station to which access can, in some embodiments, be restricted to certain authorized subscribers, whether in a home, collective or business framework.

In the framework of an embodiment of the invention, the expression “wireless access station” refers to a private access station or Home Gateway (HG), that is to say equipment that is installed on the premises of the user (individual person, collective or business) and provides wireless access to the user's terminal and access to the IP/DSL (Internet Protocol/Digital Subscriber Line) transport network. This can in particular be a home gateway that is connected to the ADSL network, is equipped with a 3G UMTS wireless antenna, and includes a UMTS/IP interface module between the wireless antenna and the home gateway.

Clearly the plurality of home gateways forms a “microscopic” access network, organized as a plurality of microcells or femtocells each of which is associated with the particular wireless antenna of a home gateway.

In the framework of an embodiment of the invention, the expression “wireless access station” also refers to a public wireless access station to an operator's 2G or 3G “macroscopic” network.

The remainder of the description describes an embodiment of the invention in the context of private access stations forming a “microscopic” network.

Access to these private access stations is controlled by a controller, which is an equipment installed on the operator premises which manages HG private access networks. All incoming and outgoing end-user traffic of the HG is managed by the controller.

An embodiment of the present invention can be applied to 2G cellular networks (GSM, GPRS), 3G cellular networks (UMTS), and future developments thereof.

In the context of second generation networks, the private access station can be the BTS (Base Transceiver Station) installed on the customer premises and the controller can be the BSC (Base Station Controller).

In the context of third generation networks, the private access station can be the NodeB installed on the customer premises and can provide functions that are usually associated with entities of the 3G network, such as the RNC (Wireless Network Controller), the MSC (Mobile Switching Center) or the SGSN (Serving GPRS Support Node). The controller is like an RNC but can have additional functions, in particular functions relating to access control mechanisms.

The remainder of the description is entirely dedicated to one particular embodiment of the invention in the context of a UMTS network.

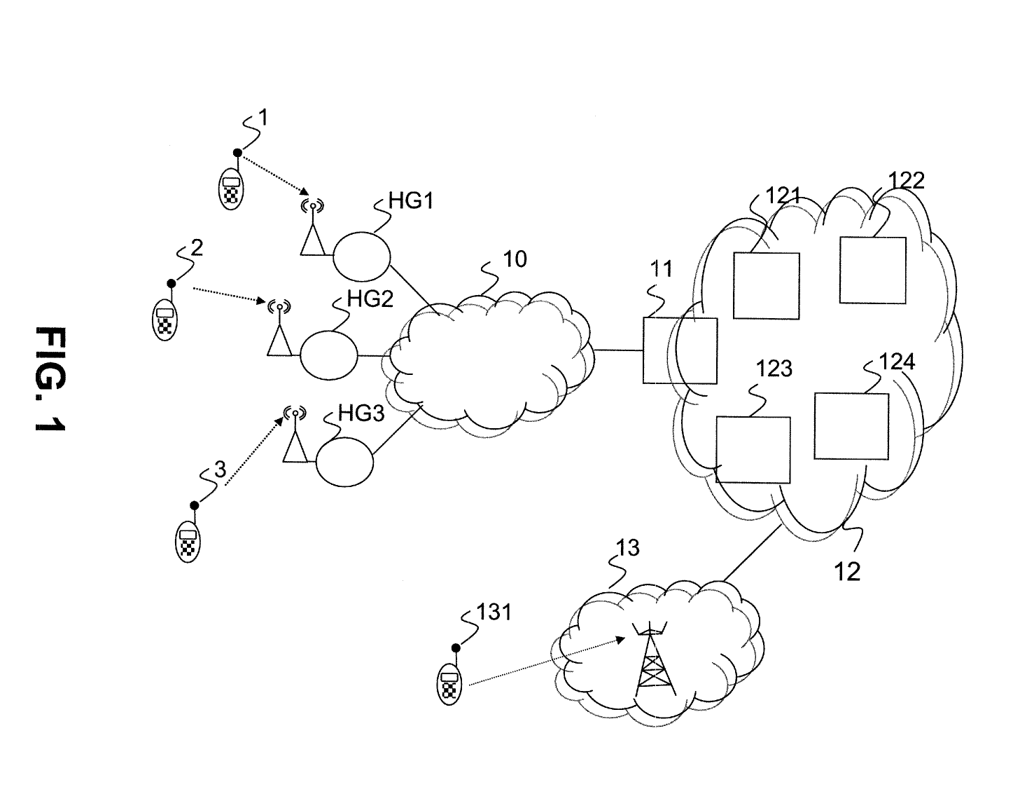

FIG. 1 illustrates the architecture of a “microscopic” access network dedicated to a home wireless coverage service and including a plurality of private access stations, three of which HG1, HG2, and HG3 are represented. The private access stations HG1 to HG3 are each connected to a controller 11 via an IP network 10, such as the Internet, or an ADSL network. The controller 11 constitutes a gateway between the access network consisting of the private access stations HG1 to HG3, of which it is part, and the operator's core network 12, which manages the service offered and the routing of calls to fixed networks (not represented in FIG. 1) such as the fixed public telephone network, the Internet, etc.

The core network 12 includes a number of standard UMTS network entities, such as:

a Mobile Switching Center (MSC) 121, which is responsible for managing circuit mode services of the mobile terminals 1 to 4 and 131 that are registered in the geographical area that it manages;

a Home Location Register (HLR) 122, which is a database containing information concerning users' subscription terms and conditions and the features of the services subscribed to; it also contains relatively coarse subscriber location information (such as the MSC or the SGSN at which the subscriber is located);

a Serving GPRS Support Node (SGSN) 123, which transfers data in packet mode to the Internet, to Intranet networks or to service platforms (and vice-versa). This connection is effected via a data routing gateway in the form of a Gateway GPRS Support Node (GGSN) 124.

Their roles and functions are identical to those of a standard UMTS network and are therefore not described in more detail here.

There is also represented in FIG. 1 the operator's “macroscopic” UMTS network, in the form of an access network 13 consisting of public access stations, namely base stations, accessible from a plurality of user mobile terminals 131, this access network 13 being connected to the core network 12.

Each private access station HG1 to HG3 can be accessed by one or more authorized subscriber terminals if an access control mechanism is implemented. If no access control mechanism is implemented, it can be accessed by any terminal.

Such mobile terminals can include mobile cellular wireless communications terminals, communicating personnel digital assistants (PDA), communicating laptop computers, and SmartPhones able to communicate with the operator's network. These are standard UMTS mobile terminals, which do not need to be modified in any way to be used in the context of an embodiment of the invention.

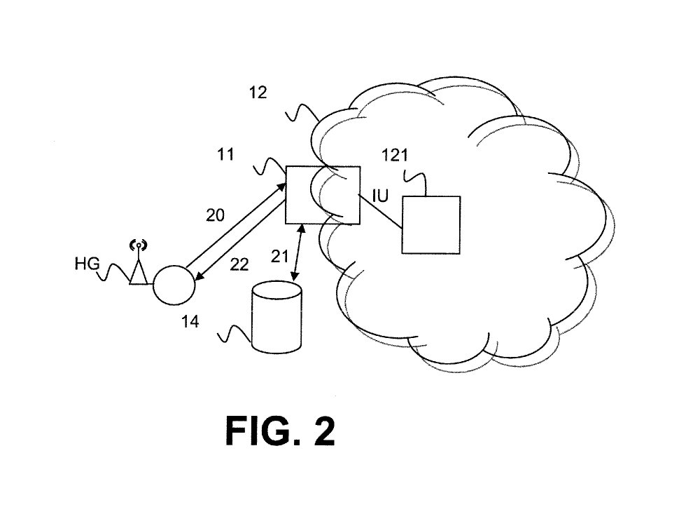

The method of an embodiment of the invention for configuring a parameter of the home gateway HG1 is described below with particular reference to FIG. 2.

When connecting to the wireless network, a home gateway HG1 newly installed on the premises of a customer sends a configuration request 20 to the controller 11. The address of the controller 11 for the home gateway concerned is communicated to the customer when subscribing to the service, for example, or is resolved by a DNS (Domain Name System) request. Such requests include a location indication for the home gateway. This is, for example, the IP address of the ADSL connection to which the customer subscribes, information on the “macroscopic” 2G or 3G network covering the terminal, such as the PLMN or the LAC, or a cell identifier.

The request relates to at least one configuration parameter. Below, particular consideration is given to the parameters LAC, SAC, and SAI defined above. However, an embodiment of the present invention is not limited to these particular configuration parameters, and applies to any type of parameter of configuration that can be linked to the geographical location of the home gateway, for example a scrambling code. Such scrambling codes are used in a 3G network implementing a Code Division Multiple Access (CDMA) access technology, to reduce the impact of interference between calls of two adjacent terminals using the same sending frequency.

On receiving the request, the controller 11 assigns said home gateway HG1 a geographical area GA1 as a function of the location indication contained in the request. It should be noted that the choice of the geographical area and its size in particular depend on the type of configuration parameter concerned. For example, for configuring the parameters SAI, LAC, and SAC, the geographical area can correspond to a town or to a neighborhood and be designated by the post code of that town or neighborhood, for example.

The controller then interrogates a database 14 containing a list of possible values of the parameter concerned for the geographical area concerned.

Such databases can be located in the network, centralized and available for interrogation by all the controllers when a number of controllers are deployed in the access network of an embodiment of the invention. They can also be local to one controller.

The controller selects a parameter value for the type of home gateway HG1 included in the list of values supplied by the database 13 and satisfying at least one constraint linked to the location of the home gateway HG1. Finally, it sends a response message 22 to the home gateway HG1.

According to one aspect of the invention, the controller has to assign a parameter value to the home gateway HG1 that satisfies a first constraint on selecting the value of the parameter from a list of possible values defined by the communications network 12 for the “macroscopic” network.

For the parameter LAC, for example, there are 65533 possible values for a given PLMN, and thus for the whole of the mobile network of a given operator in a given country. These 65533 possible values are then divided between the MSC of the mobile network. Consequently, for the controller 11 attached to the MSC 121, the number of possible values for configuring the parameter LAC of a home gateway for which it is responsible is the subset of the 65533 values assigned by the communications network 12 to the geographical area GA of the MSC 121. For example, for the 15^{th} arrondissement of Paris, there are two values of LAC, referred to below as LAC_{CN} (CN standing for communications network), equal to 1 and 2.

In contrast, for the parameter SAC, there are 65534 possible values for a given MSC but (for the present example of the 15^{th} arrondissement of Paris) the communications network provides for re-use of the parameter SAC_{CN}=1 in the two LAI of the same area, which gives two values of SAI_{CN} in the communications network.

The table below gives the SAI_{CN} values assigned on the communications network side and the pseudo-SAI values that can be used to assign parameters to an access station. Thus a SAI is denoted 208-01-6-15, 208 being the MCC (Mobile Country Code: 208 for France), 01 being the MNC (Mobile Network Code: 01 for Orange), 6 being the LAC, and 15 being the SAC.

TABLE 1

| | | Values of SAI_{CN} |
|---|---|---|
| | Space of possible SAI | predefined in the |
| Geographical area | pseudovalues | communications network |
| 75013 | 208-01-600.699-1.65535 | 208-01-6-15 |
| | 208-01-500.599-1.65535 | 208-01-5-15 |
| 75014 | 208-01-400.499-1.65535 | 208-01-4-14 |
| | 208-01-300.399-1.65535 | 208-01-3-14 |
| 75015 | 208-01-200.299-1.65535 | 208-01-2-1 |
| | 208-01-100.199-1.65535 | 208-01-1-1 |

A network entity, for example the controller 11, advantageously consults a list of pseudovalues available in the database 14. When it has selected a pseudovalue from the list, it updates the list by eliminating from the list of available values the value that has been selected.

On receiving a request to access a service from said home gateway, the method of an embodiment of the invention executes a step of converting the pseudovalue into a value of said parameter satisfying the first constraint.

It should be recalled that the parameter SAI is formed by concatenating the PLMN, LAC, and SAC values. Now, the PLMN has a fixed value for a given operator in a given country. Consequently, the configuration of the parameter SAI in a fixed PLMN is closely linked to that of the parameters defined above (LAC, SAC).

The step of converting pseudovalues into a possible value defined by the communications network is advantageously executed by consulting a table of correspondence stored in a database, for example the same database 14.

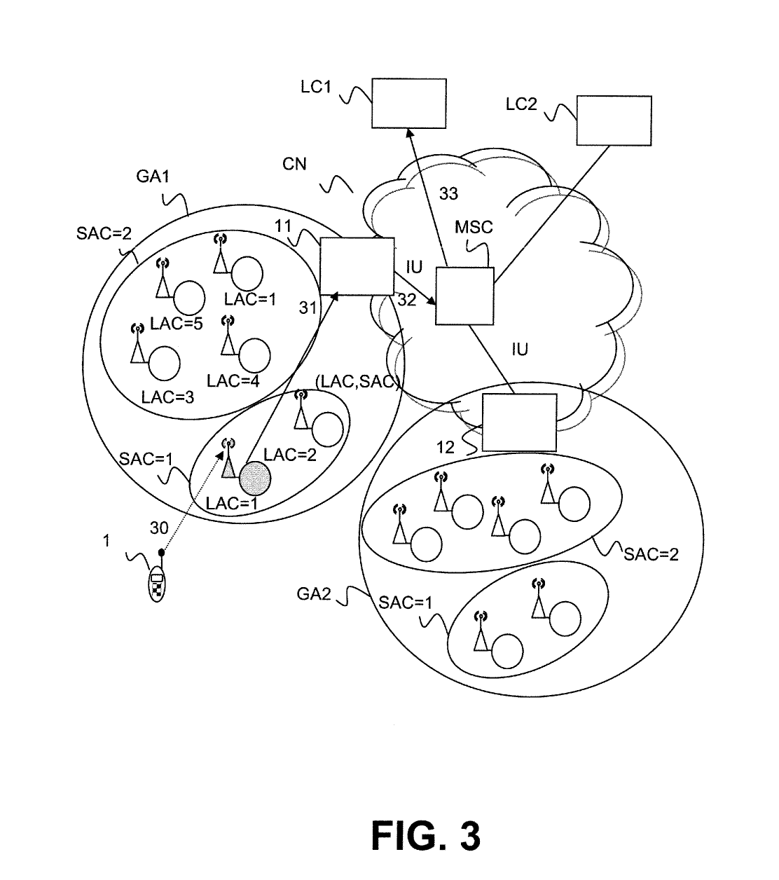

FIG. 3 shows, by way of example, the routing of an emergency call coming from a mobile terminal 1 attached to the home gateway HG1. The home gateway HG1 is situated in the geographical area GA1 consisting of the 15^{th} arrondissement of Paris. The terminal 1 sends a call set-up request to the home gateway HG1 (step 30), which forwards the request to its controller 11 (step 31). It should be noted that this forwarding is effected by encapsulating the call set-up request in IP frames conveyed over the IP network 10 (not represented in FIG. 3). This request includes configuration parameters for the home gateway HG1, including the pseudovalue of the parameter SAI assigned according to an embodiment of the invention. On reception of this request, the controller 11 converts this pseudovalue into a value of the parameter SAI defined by the communications network, which guarantees a unique and unambiguous value of SAI. The request containing the converted parameter value is then routed to the MSC via an Iu-CS interface (step 32). This kind of interface between an RNC and an MSC is defined by the 3GPP Technical Specification TS 25.410. Using this unique and unambiguous value of the parameter SAI, the MSC can route the call to the nearest local emergency call processing center LC1 (step 33) and provide that same emergency call processing center with the current location of the subscriber based on the geographical area, for example the post code of the home gateway to which the mobile terminal is attached.

According to another aspect of the invention, the assignment step is intended to satisfy a second constraint, namely that there should be only one occurrence of said value of said parameter among the home gateways adjacent said home gateway in said geographical area. This second constraint relates in particular to the parameter LAC, which is used by the access control mechanism controlling access to a home gateway, for example.

For the parameter LAC, the second constraint can be considered in combination with the first, because the chosen value must be found in a list of values defined by the communications network.

In this regard, it is desirable to set the parameters of each home gateway with a different value of the parameter LAC, at least for adjacent home gateways (two private access stations having the same location area can be tolerated if they are very far apart). Referring by way of example to the 3GPP Technical Specification TS 24.008 mentioned above, such parameter values have the consequence of triggering a location area update procedure in a mobile terminal when it attempts to attach to a home gateway. In the context of this procedure, it is essential to distinguish between two terminals to which a mobile terminal is likely to attempt to attach successively through different values of the parameter LAC.

To satisfy this second constraint, the assignment step must recover the values assigned to the adjacent home gateways for the parameter concerned. This recovery can be effected by the home gateway, which collects information concerning the configuration of its neighbors by monitoring the messages that they broadcast and then sends the collected information to the controller. It can also be implemented by the controller itself, which interrogates the terminals adjacent the terminal waiting to be configured.

It should be noted that, in both these situations, the controller does not need to know beforehand the terminals adjacent the home gateway. It is therefore necessary to provide the controller with location information concerning the adjacent terminals, in order for it to be able to identify them and look up the configuration values concerning them in its database. This is done by the terminal itself, for example. The dynamic assignment step then updates the list of possible values for the home gateway by eliminating said adjacent values therefrom.

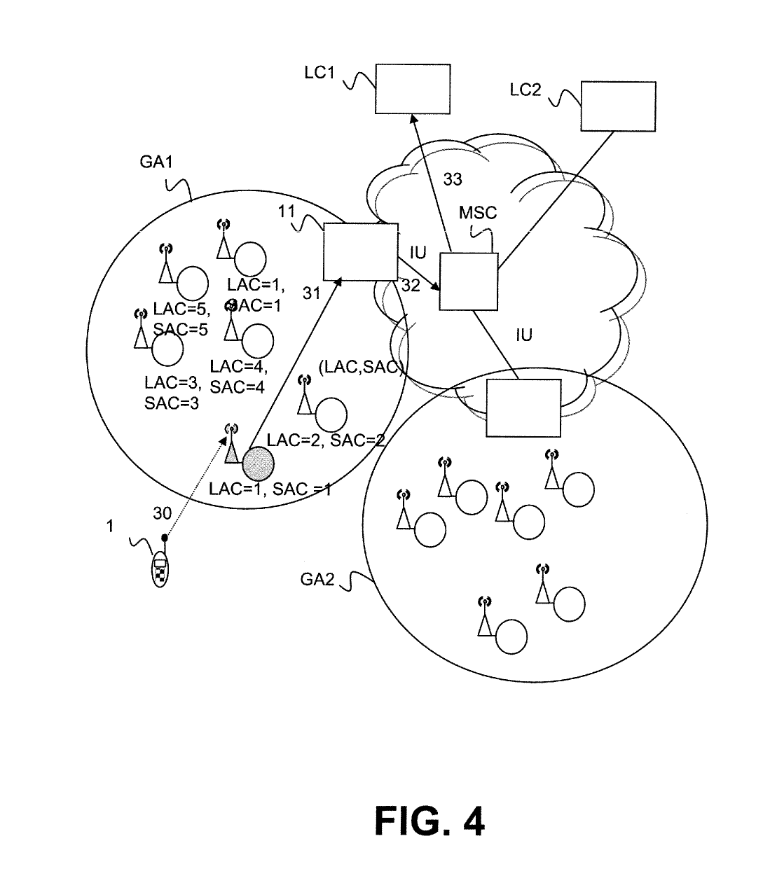

An example of dynamic assignment in accordance with an embodiment of the invention that satisfies this second constraint is described below with reference to FIG. 4. In this example, this second constraint is applied not only to the parameter LAC but also to the parameter SC (Scrambling Code).

According to another aspect of the invention, said assignment step satisfies a third constraint imposing a single occurrence of a value of said parameter in said geographical area.

This third constraint applies to the parameter SAI that can be used to determine the attachment station of a mobile terminal. This same parameter is used on the communications network side to route emergency calls as a function of the location of the mobile terminal. Nevertheless, it is clear that this limited number of values in the communications network is not compatible with the use of a “microscopic” network, which contains a multiplicity of home gateways in the same geographical area, and the actual number thereof is not under the operator's control.

To solve this problem, the assignment step of the method of an embodiment of the invention assigns a pseudovalue of the parameter to said home gateway HG and said pseudovalue is selected so that it satisfies this third constraint.

It should be noted that this third constraint can be applied to a parameter independently of or in combination with the first constraint.

For the parameter SAI, for example, it is desirable for the two constraints to be satisfied in combination. Thus in the same geographical area the use of pseudovalues allows a very long list of possible values (in particular enabling a unique value SAI to be assigned to a terminal), at the same time as guaranteeing on the communications network side a limited number of SAI in the translation and routing tables for emergency calls. With reference to the example set out in table 1, the operator can therefore use 13.107.000 pseudovalues of SAI at the wireless access stations at the same time as declaring in the communications network only two values of the parameter SAI for the geographical area consisting of the 15^{th} arrondissement.

Satisfying the third constraint in accordance with an embodiment of the invention also has advantages for specific applications such as broadcasting. The broadcasting application, defined in 3GPP Technical Specification TS 25.419, enables a service terminal to broadcast messages to mobile terminals attached to it within its service area. Clearly assigning an SAI pseudovalue specific to a home gateway could enable a service to be offered enabling subscribers to the service to broadcast personalized messages, for example referring to the home gateway's subscriber, of the type “Welcome to the home gateway of Forename Surname!”.

It should be noted that this aspect of the invention can be implemented only if the home gateway HG implements the RNC functions and therefore interprets the value of the parameter concerned. In this specific instance, the controller relays messages that it receives from the core network addressed to the home gateway HG and, to do this, converts the value of the parameter into a pseudovalue satisfying the above-mentioned first and third constraints. In contrast, if the RNC functions are implemented by the controller 11, the meaning of the value of the parameter SAC remains local to the controller and no parameter SAI is assigned to the home gateway.

According to another aspect of the invention, the assignment step satisfies a fourth constraint that imposes a homogeneous distribution of instances of the value of a parameter among the home gateways adjacent a home gateway in its geographical area. This fourth constraint concerns in particular the parameter LAC, in respect of which it has already been explained that two private access stations having the same value and therefore the same location area can be tolerated if they are very far apart. In this regard, a geographical area is considered that is larger than the area attached to an emergency area, i.e. the geographical area concerned here is that controlled by the MSC.

According to this aspect of the invention, the list of possible values stored in the database 14 indicates a number of instances of said value for the home gateways in the geographical area of the MSC and the selection substep selects the value for which the number of instances already assigned in said geographical area is the lowest. Selection from the list of possible values can use a pseudorandom algorithm in a technique known to the person skilled in the art that is not described here. This minimizes the risk of a mobile terminal attempting to attach successively to home gateways having the same value of the parameter LAC.

For the parameter LAC, this fourth constraint is cumulative with the second constraint. It can nevertheless be considered independently of the second constraint for other types of parameter.

It should be noted that this aspect of the invention can be implemented independently of the other aspects already described. In particular, implementation of the third and fourth constraints is not necessarily combined with that of the first and third constraints.

According to one particular embodiment of the invention, the steps of the method of the invention of configuring a service access station are determined by the instructions of a computer program incorporated in a data processing device such as the controller 11. The program includes program instructions which execute the steps of the method of an embodiment of the invention when said program is loaded into and executed in the device whose operation is then controlled by the execution of the program.

Consequently, an embodiment of the invention also applies to a computer program, in particular a computer program on or in an information storage medium, adapted to implement an embodiment of the invention. This program can use any programming language and take the form of source code, object code or an intermediate code between source code and object code, such as a partially-compiled form, or any other form that is desirable for implementing the method of an embodiment of the invention.

An exemplary embodiment of the disclosure alleviates the drawbacks of the prior art.

An exemplary embodiment provides a solution for dynamically configuring a service access station that was not taken into account when planning the access network.

An exemplary embodiment proposes a method of configuring a service access station in an access network that adapts easily to an increasing number of private access networks.

Although the present disclosure has been described with reference to one or more examples, workers skilled in the art will recognize that changes may be made in form and detail without departing from the scope of the disclosure and/or the appended claims.

1-7. (canceled)

8. A method of configuring a parameter of a wireless access station providing access to a service provided by a communications network, said method being characterized in that, the service being accessible via a plurality of wireless access stations forming an access network to said communications network, said method includes:
on reception of a request for configuration of said parameter including an indication of a location said wireless access station, a step of assigning a geographical area to said wireless access station on the basis of said location indication;
a step of dynamically assigning a pseudovalue to the parameter satisfying a constraint associated with the geographical location of the wireless access station; and
on reception of a request to access a service from said wireless access station, a step of converting the pseudovalue into a value of the parameter selected from a list of possible values defined by the communications network for said geographical area.

9. A configuration method according to claim 8, wherein the dynamic assignment step satisfies a constraint permitting only one occurrence of said value of said parameter amongst private access stations adjacent to said wireless access station in said geographical area.

10. A configuration method according to claim 8, wherein the dynamic assignment step includes a substep of interrogating a local database containing a list of pseudovalues available for the parameter in said geographical area and a substep of selecting a pseudovalue to be assigned to said wireless access station from said list of available pseudovalues.

11. A configuration method according to claim 8, wherein said conversion step includes a substep of interrogating a database containing a table for converting said pseudovalue into the possible value selected for said parameter in said geographical area.

12. A configuration method according to claim 8, wherein the dynamic assignment step satisfies a constraint permitting only one occurrence of said value of said parameter in said geographical area.

13. A controller of access stations to a service provided by a communications network, said access stations being wireless access stations to a service of said network connected to said controller constituting a gateway to said communications network, said controller comprising:
means for, on reception of a request for configuration of said parameter including an indication of the location of said wireless access station, assigning a geographical area to said wireless access station on the basis of said location indication;
means for dynamically assigning a pseudovalue to the parameter satisfying a constraint associated with the location of the wireless access station;
means for, on reception of a request to access a service from said wireless access station, converting the pseudovalue into a value of the parameter selected from a list of possible values defined by the communications network for said geographical area.

14. An access station to a service provided by a communications network, wherein the access station is wireless and comprises:
means for sending a request to configure a parameter including at least a location indication to a controller constituting a gateway to the communications network; and
means for receiving a pseudovalue of the parameter satisfying a constraint associated with the location of the wireless access station, wherein the service is accessible via a plurality of wireless access stations connected to said communications network.

15. An access network to a service provided by a communications network, comprising:
a plurality of wireless access stations connected to said communications network, at least one of the wireless access stations including:
means for sending a request to configure a parameter including at least a location indication to a controller constituting a gateway to the communications network, and
means for receiving a pseudovalue of the parameter, said controller being adapted to assign a geographical area to said wireless access station on the basis of said location indication, to assign the pseudovalue to the parameter satisfying a constraint associated with the location of said wireless access terminal, and, on receiving a request from said access station for access to a service, converting the pseudovalue into a parameter value selected from a list of possible values defined by the communications network for said geographical area.

16. A computer program product stored on a computer-readable medium and adapted to be executed by a microprocessor, wherein the product includes program code instructions for executing a method of configuring a parameter of a wireless access station providing access to a service provided by a communications network, said method being characterized in that, the service being accessible via a plurality of wireless access stations forming an access network to said communications network, wherein the method comprises:
on reception of a request for configuration of said parameter including an indication of a location said wireless access station, a step of assigning a geographical area to said wireless access station on the basis of said location indication;
a step of dynamically assigning a pseudovalue to the parameter satisfying a constraint associated with the geographical location of the wireless access station; and
on reception of a request to access a service from said wireless access station, a step of converting the pseudovalue into a value of the parameter selected from a list of possible values defined by the communications network for said geographical area.
